(19) United States
(12) Patent Application Publication
(10) Pub. No.: US 2016/0176631 A1
(43) Pub. Date: Jun. 23, 2016

(54) MOUNTABLE RECEPTACLE FOR THE TEMPORARY PLACEMENT OF LIGHTWEIGHT TRASH OR DEBRIS

(71) Applicant: Karen M. Amestoy, Stockton, CA (US)

(72) Inventor: Karen M. Amestoy, Stockton, CA (US)

(21) Appl. No.: 14/224,074

(22) Filed: Mar. 25, 2014

(51) Int. Cl. B65F 1/14

(52) U.S. Cl. CPC B65F 1/1607; B65F 1/141; B65F 1/1646

(57) ABSTRACT

A mountable receptacle designed to attach to a means of transportation for the purpose of temporary storage of lightweight trash, until the means of transportation reaches a stationary or resting place, at which point the trash can be removed from the receptacle and placed in a permanent vessel. The receptacle is preferably plastic, and comprises of a pliable opening near the top for insertion of trash, and a detachable base to aid in the removal of the trash without having to remove the receptacle from its mount. Ideal for use on a golf cart, a golfer can maintain control of their lightweight trash, thus keeping litter off of the Golf Course, and allowing for efficient removal of the trash when the round of golf is completed. The receptacle can be attached to virtually any portable device, such as strollers, wheelchairs, bicycles, and push carts.

### BACKGROUND

Golf Courses incur large amounts of lightweight trash littered among the property, due to the fact that as the Golf Cart travels the golf course, wind force causes lightweight trash to “fly” out of the front storage compartment of the carts. These items include, but are not limited to; potato chip bags, granola and energy bar wrappers, snack pouches, napkins, cigar and cigarette cellophane, To-Go Lids, golf ball sleeves, etc.

Currently, golfers must either place lightweight trash in the front compartment of the cart where there is no door or cover to keep items contained, anchor the trash down in the rear basket and hope that the anchor doesn't shift during the round of golf, or secure the trash in one of the small zippered compartments located on the golf bag. These methods provide to be overall inconvenient and/or ineffective. Most golf courses are equipped with stationary trash receptacles, but it is difficult to contain the lightweight trash until one of these receptacles is reached. The resulting issue is a pristine golf course littered with unsightly trash that can be harmful to the environment, as well as costly in regards to labor management. Many of these items need to be manually retrieved before a mower, puncher, or other large piece of equipment can effectively perform its function on the fairways and rough areas of the golf course.

To date, there is no apparatus that golf cart manufacturers or golf accessory retailers make to assist with efficient golf course waste management. The Mountable Receptacle is designed to be both easy to use for the consumer, as well as easy to clean/maintain by golf cart maintenance staff.

### SUMMARY

When the mountable receptacle is assembled as described and mounted properly to the golf cart, the amount of debris that litters the golf course is dramatically reduced, if not completely eliminated when used regularly and properly. Because there is no place on a golf cart that can securely contain lightweight trash, the mountable receptacle securely contains these lightweight objects, keeping litter off of the golf course, and allowing for efficient removal of the trash when the golf cart is done being used.

### DRAWINGS

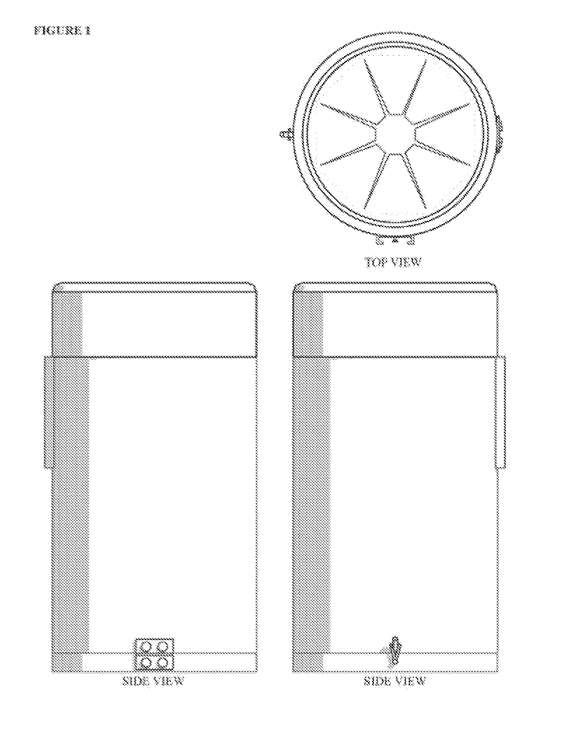

### Figures FIG. 1 shows a perspective of the receptacle in its full embodiment.

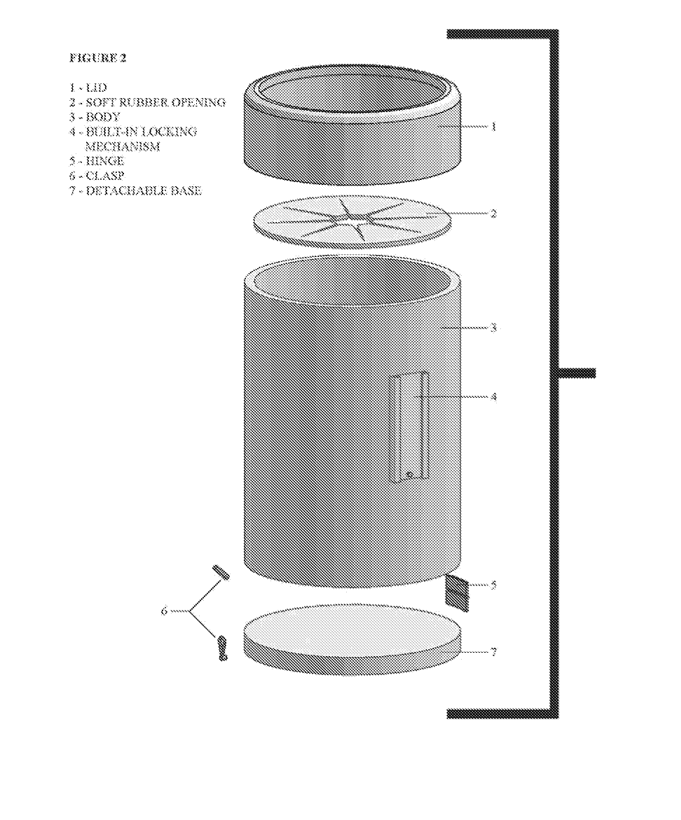

FIG. 2 shows an exploded or deconstructed view of the parts of the unit and the importance of the order of their assembly.

### REFERENCE NUMERALS

1—Lid
2—Soft Rubber opening
3—Body
4—Built-in locking mechanism
5—Hinge
6—Clasp
7—Detachable Base

### DETAILED DESCRIPTION

### FIG. 2

One embodiment of the device is illustrated in FIG. 2 (Exploded View).

The pliable opening (2) is built into the lid (1). The pliable opening allows for trash to be inserted into the unit without having to open the lid (much like the soft opening of a garbage disposal, or the slotted opening of a cleaning wipe canister). This feature also allows for the insertion of additional trash without having to remove the lid; which could increase the risk of previously inserted trash becoming displaced. The trash is now secured within the body of the unit as the golf cart and travels the course. The lid is attached to the body of the unit (3). The lid can be permanent, or fabricated as a threaded lid for ease of part replacement and cleaning. The body of the unit is cylindrical in shape, and made of a durable material that can withstand wet trash, but is also lightweight. If the unit is fabricated out of an appropriate material, cigar and cigarette butts can also be added to the unit during the course of use. A durable plastic material would be ideal, as it would match the standard plastic molding of most golf carts in production today, but other materials such as metal or lightweight wood could be used as well. The unit is shown to be retrofitted with an exterior vertical slide-locking mechanism (4) so that the unit can remain universal in production/fabrication. This allows for the universal unit to be attached to various shaped brackets. There are many different brands and models of golf carts on the market, and the bracket would be fabricated to fit the various models of carts. This unique feature would also allow for brackets to be designed to fit other portable items such as strollers, wheelchairs, scooters, bicycles, and push carts. At the bottom of the unit is a detachable base (7) that is secured to the unit with a hinge (5) and clasp (6). This feature allows for the trash to be removed from the unit without having to remove the entire receptacle from the object to which it was mounted. The hinge allows for the base to not be separated from the unit, the clasp keeps the base secure during use.

In the example of a golf cart, when a cart is returned to the storage facility after a round of golf, a cart attendant can release the clasp and collect the trash in a small container without having to touch the trash or remove the receptacle from its mount, thus saving valuable time in cart detail labor Depending on the material that the receptacle is made of, it can potentially be hosed off or rinsed out and the bottom can be left open so that the receptacle can dry out until the cart is used again.

### Operation

In operation, one uses the receptacle during their round of golf, or outdoor activity where stationary trash receptacles are limited or non-existent. The trash is inserted into the receptacle through the soft pliable opening, and held in the body of the receptacle until the activity is finished. When the unit or device that the receptacle has been attached to becomes stationary, the bottom of the receptacle can be opened without having to remove the receptacle from said unit or device and the trash can be removed either by hand or through natural gravitational pull and into a garbage can.

### Advantages

From the description above, a number of advantages of this mountable receptacle become evident;
a) the amount of litter found on the golf course has potential to be greatly reduced
b) golfers can securely and conveniently discard of their lightweight trash during their round of golf
c) golf course maintenance crews would reduce the amount of time spent collecting trash on a course before they can perform their maintenance functions
d) cart cleaning crews would have an efficient way of collecting the trash when detailing used carts
e) the universal slide-lock mechanism allows for easy fabrication of brackets to fit any size or shape cart
f) the universal slide-lock mechanism also allows for the fabrication of brackets to fit items other golf carts

### Conclusion, Ramifications, and Scope

Accordingly, the reader will see that the construction of the receptacle serves its purpose when it is assembled in the manner shown, and that it can easily and efficiently solve a problem that many assume to be unfixable, or not previously realized. The rubber opening is necessary to keep the litter secure inside the body. The hinged bottom is necessary so that the unit does not have to be removed from the cart for trash removal.

Golfers can maintain the trash they accumulate during their round of golf without the worry of the trash finding its way onto the course. Also, when the golf cart is returned to the storage area for cleaning, the cart staff can easily empty the unit without having to remove it from its mount. Furthermore, maintenance crews are able to tend to their necessary course maintenance tasks without having to first clear the course of trash. Additionally, the receptacle has additional advantages in that:
it could be resized and retrofitted to fit Wagons, Strollers, Scooters, Wheelchairs, Push Carts, Tractors, Motorcycles, and Bicycles, thus eliminating waste on trails, in parks, in public places, as well as on farms and ranches.
the installation of receptacles can drastically reduce labor costs in golf course maintenance staff as well as cart service staff.
it allows for the safe disposal of cigarette and cigar butts when constructed of an appropriate material.
it can be produced in mass to be installed as a standard accessory on all golf cart fleets, as well as fabricated to be an aftermarket accessory.

Although the description above contains certain specifications, these should not be construed as limiting the scope of the embodiment but as merely providing illustrations of some of several embodiments. For example, the receptacle can have other shapes, such as oval, square, or rectangular; the opening can be affixed in a top, side, or rear mount; the receptacle can be made of a variety of materials such as wood, metal, or plastic; the bottom can be attached by different means, and the locking mechanism can be fabricated in multiple ways. The unit is also not only designed to be used for golf carts, but for any mode of transportation that has an area with enough clearance to install the receptacle, including but not limited to bikes, scooters, wheelchairs, and strollers.

Thus the scope of the embodiment should be determined by the appended claims and their legal equivalents, rather than by the examples given.

1. a mountable receptacle, comprising
a) a pliable opening near the upper end allowing for the insertion of objects without having to remove a lid from said receptacle, and
b) a hinged or threaded lower end to allow for the removal inserted items without having to remove the receptacle from its mount,
whereby allowing means for the temporary containment of lightweight objects as well as ease of removal for permanent disposal.

2. The receptacle of claim 1 wherein said body is manufactured with a locking mechanism, allowing for the attachment of various sized mounting brackets.
